(19) United States
(12) Patent Application Publication
(10) Pub. No.: US 2025/0135745 A1
(43) Pub. Date: May 1, 2025

(54) ANTISTATIC FABRIC ARTICLE

(71) Applicant: 3M INNOVATIVE PROPERTIES COMPANY, St. Paul, MN (US)

(72) Inventors: Mahfuza B. Ali, Mendota Heights, MN (US); Christopher P. Gerlach, Woodbury, MN (US); Claudia M. Mulvaney, Woodbury, MN (US); Jamie N. Wheeler, St. Paul, MN (US)

(21) Appl. No.: 18/683,112

(22) PCT Filed: Aug. 5, 2022
(86) PCT No.: PCT/IB2022/057339

§ 371 Date: Feb. 12, 2024

Related U.S. Application Data
(60) Provisional application No. 63/233,100, filed on Aug. 13, 2021.

(51) Int. Cl. B32B 5/02; B32B 27/08; B32B 27/12; B32B 27/28; B32B 27/30; B32B 43/00

(52) U.S. Cl. CPC B32B 5/022; B32B 27/08; B32B 27/12; B32B 27/286; B32B 27/308; B32B 43/006; B32B 2305/20; B32B 2307/202; B32B 2307/21; B32B 2405/00

(57) ABSTRACT

Aspects of the present disclosure relate to antistatic articles, including systems, and methods of use thereof. The article can include a fabric layer having a first fabric side and a second fabric side, and a polymeric antistatic layer disposed in a direction towards the second fabric side. The polymeric antistatic layer comprises an antistatic polymer.

### BACKGROUND

Surface protection fabrics can provide surface protection from fluids, dirt, and other contaminants. Examples of surface protection fabrics can include the Self-Stick Liquid Protection Fabric by 3M (Saint Paul, MN), part number 51005. The Self-Stick Liquid Protection Fabric is an adhesive-based surface protection material that features a polymer film layer that prevents grease, grime, solvents, and other liquids from seeping through and a non-woven surface.

Antistatic compounds, such as those described in U.S. Pat. No. 9,260,612 to Pellerite et al, can be used with films.

### BRIEF SUMMARY

Aspects of the present disclosure relate to an article that is generally static dissipating. The article can include a fabric layer having a first fabric side and a second fabric side, and a polymeric antistatic layer disposed in a direction towards the second fabric side. The polymeric antistatic layer comprises an antistatic polymer.

In some embodiments, the fabric layer comprises a nonwoven fabric, woven fabric, knitted fabric, or combinations thereof.

In some embodiments, the antistatic polymer is a primer for an adhesive.

In some embodiments, the article also includes a polymer film layer having a first film side and a second film side. The polymer film layer is sandwiched between the fabric layer and the polymeric antistatic layer.

In some embodiments, the first film side can be disposed on the second fabric side, and the polymeric antistatic layer is disposed on the second film side.

In some embodiments, the polymeric antistatic layer has a first antistatic side and a second antistatic side. The first antistatic side can contact the second film side.

In some embodiments, the article includes an adhesive layer having a first adhesive side and a second adhesive side, wherein the first adhesive side is disposed on the polymeric antistatic layer.

In some embodiments, the first adhesive side is disposed on the second antistatic side.

In some embodiments, the article has a charge decay of less than 0.02 seconds at less than 30% relative humidity and greater than 16% relative humidity.

In some embodiments, the polymeric antistatic layer comprises an acrylate polymer which can include a crosslinkable monomer.

In some embodiments, the acrylate polymer comprises a cationic monomer having the formula:

CH₂═CR¹COZ(CH₂)ₙN(R²)₃X
wherein Z is O, S, or NH; R¹ is H or CH₃; R² independently comprises an alkyl group having from 1 to 4 carbon atoms; X is an anion selected from the group consisting of halogen, nitrate, alkylsulfate, alkanesulfonate, and haloalkanesulfonate; and n=2 to 6.

In some embodiments, the cationic monomer is between 10 wt. % to 50 wt. % (inclusive) or 30 wt. % to 40 wt. % relative to a solid weight of the acrylate polymer.

In some embodiments, the acrylate polymer comprises a hydrophobic monomer comprising an aliphatic alkyl (meth)acrylate monomer having a hydrocarbon group of from 1 to 12 carbon atoms.

In some embodiments, the hydrophobic monomer comprises N-vinylpyrrolidinone, N-N-dimethylaminoethyl (meth)acrylate, or a combination thereof.

In some embodiments, the hydrophobic monomer is IOA, MMA 2EHA, butyl acrylate, or combinations thereof.

In some embodiments, the acrylate monomer is DMAEA-MCI or N, N-dimethylaminoethyl acrylate methyl chloride quaternary.

In some embodiments, the acrylate polymer is at least 95 weight percent, inclusive, of the total weight solids of the polymeric antistatic layer.

In some embodiments, the acrylate polymer comprises a crosslinking agent in an amount of at least 1 weight percent of the total weight of the polymeric antistatic layer.

In some embodiments, the crosslinking agent is a crosslinkable monomer comprising (meth)acrylic acid or a monomer having the formula:

CH₂═CR³Y;
wherein R³ is H or CH₃; and Y is selected from the group consisting of CO₂M, L-CO₂M, L-OH, and CON-L, wherein M is H or a counterion. The counterion may be selected from the group consisting of alkali metal; ammonium; and substituted mono-, di-, and trialkylammonium bearing alkyl or heteroatom-substituted alkyl groups having from 1 to 4 carbon atoms. L is a divalent linking group comprising alkylene, arylene, heteroalkylene, ether, carbonyl, ester, amido, or sulfonamido functionality, or a combination thereof.

In some embodiments, the crosslinking agent comprises diacetone acrylamide.

In some embodiments, the crosslinking agent is a difunctional crosslinking agent, the difunctional crosslinking agent can be adipic dihydrazide or adipic acid dihydrazide. The difunctional crosslinking agent can be at least 2 wt. percent, or at least 4 wt. percent of the total weight of the polymeric antistatic layer.

In some embodiments, the article does not include metal or metal salts thereof or non-polymeric quaternary ammonium salts such as ammonium chloride.

In some embodiments, only the polymeric antistatic layer can have the antistatic properties.

In some embodiments, the fabric layer or adhesive layer is not treated with antistatic materials.

In some embodiments, the polymeric antistatic layer comprises a conductive polymer layer. The conductive polymer layer can include a polymeric or co-polymeric binder and PEDOT-PSS (poly-3,4-ethylenedioxythiophene-polystyrene sulfonate) which can be dispersed within a polymeric or co-polymeric binder.

In some embodiments, the polymeric antistatic layer also includes a primer layer disposed on the conductive polymer layer.

In some embodiments, the fabric layer and the polymer film layer are heat-bonded.

In some embodiments, the fabric layer and the polymer film layer are formed from different materials.

In some embodiments, the fabric layer is formed from polyethylene terephthalate (PET) and the polymer film layer is formed from polyethylene.

Additional aspects of the present disclosure include a system that can include the article and a substrate. The article is configured to be applied (directly) to the substrate.

In some embodiments the substrate is a concrete, coated concrete, metal, ceramic, glass, carpet, wood, plastic, or combinations thereof.

Additional aspects of the present disclosure can include a method that includes applying the article to the substrate, allowing the article to protect the substrate from liquids to form a soiled article, and removing the soiled article from the substrate by peeling the soiled article.

In some embodiments, a static charge produced at an interface between the soiled article and the substrate is dissipated through the polymeric antistatic layer.

In some embodiments, the adhesive layer stays attached to the polymer film layer when the soiled article is removed.

In some embodiments, the adhesive layer stays fully attached to the polymer film layer when the soiled article is removed such that there is no residual adhesive layer remaining.

In some embodiments, the adhesive layer comprises a pressure sensitive adhesive.

Additional aspects of the present disclosure can include a method that includes receiving the article in a rolled-up configuration, and separating a first article surface of the article from a second article surface of the article, wherein a static charge produced at an interface between the first article surface and the second article surface is dissipated through the polymeric antistatic layer.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates a routine 300 in accordance with one embodiment.

FIG. 4 illustrates an aspect of the subject matter in accordance with one embodiment.

FIG. 5 illustrate an embodiment of a polymeric antistatic layer in accordance with one embodiment.

### DETAILED DESCRIPTION

Aspects of the present disclosure relate to a polymeric antistatic layer that is used in conjunction with a fabric layer to form antistatic articles that dissipate static charge.

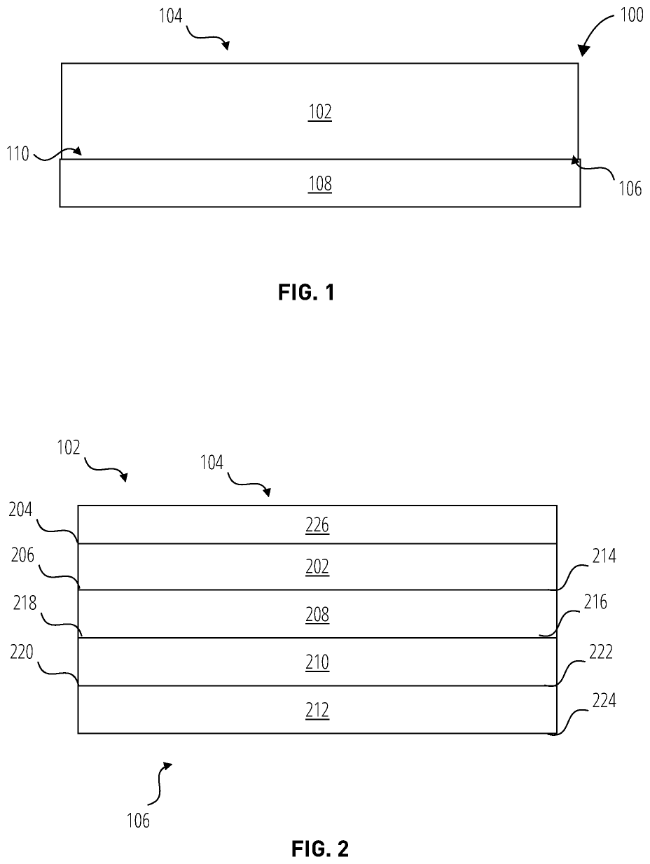

FIG. 1 illustrates a system 100 that includes the article 102. The article 102 can have a first article surface 104 and an opposing second article surface 106. In at least one embodiment, the first article surface 104 can be an absorbent side of the article 102 and the second article surface 106 can have the fastening means, which may include adhesives, mechanical fasteners (such as hook-and-loop), or magnetic attachment, or may be the non-absorbent side such as where the article is draped over a substrate 108.

The substrate 108 can refer to a surface that the article 102 is disposed on. For example, the article 102 can be attached, or adhered to, or resting on the substrate 108. In at least one embodiment, the substrate 108 can be vertically, horizontally, or diagonally oriented. For example, the substrate 108 can be a wall surface or a floor surface and can be made of materials such as concrete, coated concrete, metal, ceramic, glass, carpet, wood, plastic, or combinations thereof.

The article 102 can be disposed on the substrate 108 and form an interface 110 at the boundary between article 102 and substrate 108. The article 102 can be attached to substrate 108.

FIG. 2 illustrates an embodiment of the article 102. The article 102 can have multiple layers. For example, the article 102 can have a fabric layer 202, a polymer film layer 208, a polymeric antistatic layer 210, and an adhesive layer 212. The liquid permeable surface layer 226, polymer film layer 208 and adhesive layer 212 can be optional.

With respect to FIG. 2, references are made to “beneath”, “below”, and “above” with the assumption that the liquid permeable surface layer 226 is the topmost layer, and the adhesive layer 212 is the bottommost layer.

If the liquid permeable surface layer 226 is present, then the liquid permeable surface layer 226 can be disposed on the first fabric side 204. The liquid permeable surface layer 226 can include a plurality of apertures (not shown). The liquid permeable surface layer 226 may be constructed from such materials as polyolefins, polyamides, polyester, polycarbonate, cellulose triacetate, ethyl cellulose, regenerated cellulose, polyimides, polymethylpentene, which themselves may or may not be permeable to liquid. The liquid permeable surface layer 226 may be provided in a thickness of from 1 to 5 mils.

The fabric layer 202 is shown beneath the liquid permeable surface layer 226, between the liquid permeable surface layer 226. The fabric layer 202 can have a first fabric side 204 and a second fabric side 206. As shown, the liquid permeable surface layer 226 can contact the first fabric side 204. The polymer film layer 208 can contact the second fabric side 206.

The fabric layer 202 is capable of holding and retaining a liquid, such as a water, alcohols, polyols, or oils. In addition to retaining a liquid, the fabric layer 202 can be capable of retaining dirt from the surrounding environment and withstand abrasion. The fabric layer 202 can also include any structures to provide support for the fabric layer 202. In at least one embodiment, the fabric layer 202 and the polymer film layer 208 can be discontinuous.

The fabric layer 202 may be constructed from such materials as woven fabric, nonwoven fabric, knitted fabrics, paper, tissue, sponges, or combinations thereof, or other similar materials capable of absorbing and retaining liquid. Optionally, the fabric layer 202 may be provided with a super absorbent material like a fiber or powder such as crosslinked polyacrylates or carboxymethyl cellulose, which when exposed to liquid retains the liquid and forms a gel-like substance. The fabric layer 202 may also be preloaded with a dielectric that will be dispersed in the liquid that is absorbed into the fabric layer 202. In at least one embodiment, the fabric layer 202 does not contain any conductive elements such as metals or metal salts. In at least one embodiment, the fabric layer 202 can also include any structures to provide support for the fabric layer 202.

In at least one embodiment, the fabric layer 202 can be absorbent (e.g., capable of retaining at least 0.6 liquid oz per square foot). One example of a suitable fabric layer 202 is a PET nonwoven having a basis weight of at least 30 grams/m², at least 40 grams/m², or at least 50 grams/m². Another example is a nonwoven blend of 50% PET and 50% Rayon fibers at 50 grams/m². Another example of a suitable absorbent layer is a 5 mm thick sponge such as the Scotch-Brite R. Sponge Cloth available from 3M Company of St. Paul. Minn. In at least one embodiment, the thickness of the fabric layer 202 can be at least 0.2 mm, at least 0.5 mm, at least 1 mm, or at least 1.5 mm.

The polymer film layer 208 can be disposed between the fabric layer 202 and the polymeric antistatic layer 210. The polymer film layer 208 can have a first film side 214 that contacts the second fabric side 206 and a second film side 216 that contacts a first antistatic side 218. In at least one embodiment, the polymer film layer 208 can be heat-bonded, laminated, or extruded onto the second fabric side 206. For example, a non-woven from the fabric layer 202 can be permanently bonded to the polymer film layer 208 such that the fabric layer 202 has sufficient loft to attract dirt and other contaminants.

The polymer film layer 208 is impermeable to liquids. The polymer film layer 208 may be constructed from such materials as polyolefins, polyamides, polyester, polycarbonate, cellulose triacetate, ethyl cellulose, regenerated cellulose, polyimides, polymethylpentene. The polymer film layer 208 may be provided in a thickness of from 1 to 8 mils. In at least one embodiment, the polymer film layer 208 can be no greater than 60 mils.

In at least one embodiment, the polymer film layer 208 and fabric layer 202 can be formed from different types of materials. For example, the polymer film layer 208 can be formed from polyethylene and the fabric layer 202 can be formed from polyethylene terephthalate (PET).

Without being bound by any theory, it is thought that a polymer film layer 208 and fabric layer 202 being formed from different materials could allow improved performance of the article, particularly in certain use cases. In at least one embodiment, the fabric layer 202 and the polymer film layer 208 can have different melting temperatures. For example, the difference in melting points between the fabric layer 202 and the polymer film layer 208 can be at least 100 degrees C.

In at least one embodiment, the polymeric antistatic layer 210 can be disposed in a direction towards the second fabric side. For example, if the fabric layer 202 is directly adjacent to the polymeric antistatic layer 210, then the polymeric antistatic layer 210 would be disposed in a direction towards the second fabric side 206. If the polymer film layer 208 is sandwiched between the fabric layer 202 and the polymeric antistatic layer 210, then the polymeric antistatic layer 210 would be disposed in a direction towards the second fabric side 206 even if not directly adjacent to the fabric layer 202. In at least one embodiment, the fabric layer 202 combined with the polymer film layer 208 can be capable of keeping a liquid such as water from passing through the fabric layer 202 to a substrate.

The polymeric antistatic layer 210 can be disposed between the polymer film layer 208 and the adhesive layer 212. For example, the polymeric antistatic layer 210 can have a first antistatic side 218 that contacts the second film side 216 and a second antistatic side 220 that contacts a first adhesive side 222. In at least one embodiment, the article 102 can be similar in construction to a surface protection fabric, except including a polymeric antistatic layer 210.

The polymeric antistatic layer 210 has antistatic properties. The polymeric antistatic layer 210 can also not include metals or metal salts. In at least one embodiment, the fabric layer 202, polymer film layer 208, or adhesive layer 212 do not have antistatic properties. For example, polymeric antistatic layer 210 can be the only layer with antistatic properties. The antistatic articles disclosed herein can have a surface resistivity of less than about 1×10¹³ ohms/sq, or 1×10¹² ohms/sq, preferably less than 1×10¹⁰ ohm/sq, when measured at a relative humidity of about 25%. This antistatic performance can be achieved even with layer thicknesses of less than 1 micron.

Another advantage is that the polymeric antistatic layer 210 can be used to provide an antistatic article exhibiting a fast charge decay time which is the amount of time it takes for a static charge to decay to 10% its initial value over a given range of voltage, e.g., 5000 V to less than 500 V. The antistatic article disclosed herein may exhibit charge decay times of less than about 5 seconds, less than about 2 seconds, less than about 0.1 sec, or even less than 0.01 seconds, when measured at a relative humidity of about 40%. In some cases, these charge decay times can be observed when measured at a relative humidity of about 20% or at a relative humidity of about 10%.

The antistatic polymer of the polymeric antistatic layer 210 can also function as a primer and enhance adhesion to an adhesive layer.

In at least one embodiment, the antistatic polymer is an acrylate copolymer. For example, the functional acrylate polymer can be a cationic copolymer. Useful cationic copolymers have a number average molecular weight of greater than about 10,000 with lower molecular weight being more desirable than higher molecular weight. Useful cationic copolymers are described in US 2007/0082196 A1 (Ali et al.).

In one embodiment, the cationic copolymer consists essentially of a cationic monomer, a hydrophobic monomer, hydrophilic monomers, and hydrophilic or polar monomers.

The cationic monomer can have the formula:

CH₂═CR¹COZ(CH₂)ₙN(R²)₃X
wherein Z is O, S, or NH; R¹ is H or CH₃; R² independently comprises an alkyl group having from 1 to 4 carbon atoms; X is an anion selected from the group consisting of halogen, nitrate, alkylsulfate, alkanesulfonate, and haloalkanesulfonate; and n=2 to 6.

For example, the cationic monomer may comprise 2-acryloxyethyltrialkylammonium cation and an anion, and preferably, 2-acryloxyethyltrimethylammonium chloride or 2-acryloxyethylbutyldimethylammonium bromide. In at least one embodiment, the cationic monomer is a dimethylaminoethyl acrylate salt thereof (e.g., N,N-dimethylaminoethyl acrylate methyl chloride quaternary).

In at least one embodiment, the cationic monomer is between 10 wt. % to 50 wt. % (inclusive), or between 30 wt. % to 40 wt. % (inclusive) relative to a solid weight of the functional acrylate copolymer.

The cationic monomer may be incorporated into the cationic copolymer to impart antistatic properties. As such, the particular amount of cationic monomer used may depend upon the desired antistatic properties of the copolymer, and also on a variety of other factors including compatibility with the other monomers and other components in the composition used to form the antistatic layer, as well as the antistatic layer after it is formed.

The hydrophobic monomer comprises an aliphatic alkyl (meth)acrylate monomer having a hydrocarbon group of from 1 to 12 carbon atoms. The hydrophobic monomer can be straight-chained, branched, or cyclic, and can optionally be substituted with groups such as aromatic groups, heteroatoms such as O, and heteroatom-containing groups such as —CO—.

The hydrophobic monomer can also be free of active hydrogens such as OH, NH, and SH hydrogens. Exemplary hydrophobic monomers include ethyl acrylate, methyl methacrylate, butyl acrylate, iso-octyl (meth)acrylate, or iso-bornyl (meth)acrylate. In at least one embodiment, the hydrophobic monomer is N-vinylpyrrolidinone, N-N-dimethylaminoethyl (meth)acrylate, or a combination thereof. In at least one embodiment, the hydrophobic monomer is isooctyl acrylate (IOA), methyl methacrylate (MMA), 2-ethylhexyl acrylate (2EHA), butyl acrylate, or combinations thereof. In one example, the hydrophobic monomer can be part of a blend of monomers such as that described in U.S. Pat. No. 9,102,744 (Clapper et al.).

The hydrophobic monomer can comprise from about 0.5 to 55 wt. % (inclusive) relative to the total weight of the monomers used to form the acrylate copolymer. The particular amount of hydrophobic monomer used may depend upon the desired properties of the copolymer such as compatibility with the other monomers and other components in the composition used to form the antistatic layer, as well as the antistatic layer after it is formed.

The antistatic polymer can include crosslinkable monomers. In at least one embodiment, the hydrophilic or polar monomers enable intermolecular associations and comprise (meth)acrylic acid or a monomer having the formula:

CH₂═CR³Y
wherein R³ is H or CH₃; and Y is selected from the group consisting of CO₂M, L-CO₂M, L-OH, and CON-L, wherein M is H or a counterion. The counterion may be selected from the group consisting of alkali metal: ammonium; and substituted mono-, di-, and trialkylammonium bearing alkyl or heteroatom-substituted alkyl groups having from 1 to 4 carbon atoms. L is a divalent linking group comprising alkylene, arylene, heteroalkylene, ether, carbonyl, ester, amido, or sulfonamido functionality, or a combination thereof. Divalent linking groups that are useful as L include alkylene groups having from 2 to 6 carbon atoms. Exemplary crosslinkable monomers include hydroxyethyl (meth)acrylate, N-(methylol)(meth)acrylamide, (meth)acrylic acid, 2-carboxyethyl (meth)acrylate, and dimethylaminoethyl (meth)acrylate (DMAEMA).

In at least one embodiment, the crosslinkable monomer can include DAAM (diacetone acrylamide).

The particular crosslinkable monomer used may depend on the reactivity of the crosslinking agent (which can also be crosslinkable in nature). The crosslinkable monomer can be present in an amount of from about 2 to about 30 wt. %, or from about 15 to 25 wt. %, relative to the total weight of the antistatic copolymer. In at least one embodiment, the crosslinkable monomer can be used between 4 and 6 wt. % (inclusive) relative to the total weight of the antistatic copolymer. The particular amount of crosslinkable monomer used may depend upon the desired properties of the copolymer such as compatibility with the other monomers and other components in the composition used to form the antistatic layer, as well as the antistatic layer after it is formed.

The polymeric antistatic layer 210 can also comprise a crosslinking agent or a chemical crosslinker selected from the group consisting of melamine-formaldehyde, urea-formaldehyde, glycoluril-formaldehyde, aziridine, carbodiimide, isocyanate, epoxy, or dihydrazide crosslinkers. In at least one embodiment, the crosslinking agent can include adipic dihydrazide (ADH). In at least one embodiment, the crosslinking agent can be present in an amount of at least 2 wt. % of the total weight of the antistatic layer. By adding the crosslinking agent, the article is configured to both dissipate static and cleanly release from the substrate. For example, if the antistatic layer is not cohesive enough with the adhesive layer, then adhesive residue can remain on the substrate.

These crosslinking agents react with the pendant crosslinking groups of the binder and/or cationic copolymer as imparted by the crosslinking monomer. The crosslinking agent is selected to impart integrity and any other desired properties to the antistatic layer. Useful crosslinking agents include CYMEL 323, 325, 327, 350, and 373 (Ciba Specialty Chemicals): CX-100 (DSM Neoresins); and XAMA-7 (Hoechst Celanese). The particular choice of crosslinking agent and the amount used depends on a variety of factors such as compatibility with other components in the layer either before or after it is coated and/or cured, the desired thickness of the layer, polymerization conditions, cost, etc. Accordingly, the crosslinking agent may comprise no greater than 10 wt. % of the antistatic layer.

The relative amounts of the materials used in the antistatic layer will depend upon the particular materials being used, as well as the thickness of the layer, and the intended use of the article. In one embodiment, the antistatic layer comprises: from about 75 to about 95 wt. % (inclusive) of the cationic copolymer; and no greater than 5 wt. % of the crosslinking agent based on the total weight of solids of the polymeric antistatic layer.

The antistatic layer can have any suitable thickness provided it can impart the desired antistatic properties to the article. Generally, a thickness from about 50 nm to about 500 nm is effective, but the thickness can also be 300 to 450 nm. The antistatic layer should be thick enough to impart desirable properties but not so thick that it would detract from performance of the article.

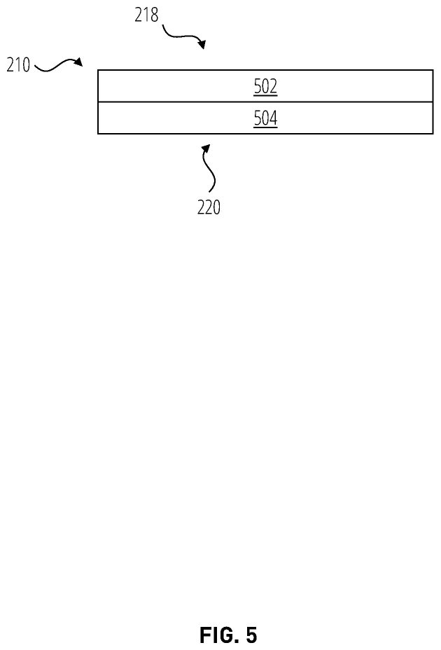

FIG. 5 illustrates an embodiment of the polymeric antistatic layer 208. In at least one embodiment, the polymeric antistatic layer 208 can be formed from two distinct layers, a conductive polymer layer 502, and a primer layer 504. The conductive polymer layer 502 can include a conductive polymer defined herein in addition to the other monomers described in FIG. 2. For example, the polymeric antistatic layer 208 can include DMAEA. In particular, the conductive polymer layer 502 can include PEDOT-PSS. In some embodiments, the conductive polymer layer 502 comprises 5-30 weight % of PEDOT-PSS. Weight percentages are calculated by dry weight, meaning that the percentages refer to the materials in the coating that has been dried to remove any volatile components such as solvents or water. In at least one embodiment, the conductive polymer layer 502 can be discontinuous while the primer layer 504 is continuous.

The primer layer 504 can include any suitable primer that promotes adhesion between the conductive polymer layer 502 and adhesive layer 212.

In at least one embodiment, the adhesive layer 212 can be formed from an adhesive, such as a pressure sensitive adhesive. Pressure sensitive adhesive compositions are well known to those of ordinary skill in the art to possess properties including the following: (1) aggressive and permanent tack. (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. In aspects of the present disclosure, the pressure sensitive adhesive is designed to be used without the application of heat in a room temperature environment. In at least one embodiment, the adhesive layer 212 can be discontinuous in the plane of the fabric layer.

Also disclosed herein is a method of making the antistatic article. The method comprises coating the antistatic composition described above onto a substrate, thereby forming a coated substrate. Typically, the components in the antistatic composition are dissolved, dispersed, or suspended in a suitable solvent for the coating step. The particular solvent used depends upon the particular components, the desired concentrations of the components, the desired thickness and nature of the layer, the coating method employed, etc. Suitable solvents include water. Generally, compositions used to form the antistatic layer comprise up to about 50 wt. % solids relative to the weight of the total composition.

The antistatic composition may be coated using a variety of coating techniques such as dip, roll, die, knife, air knife, slot, slide, wire wound rod, and curtain coating. A comprehensive discussion of coating techniques can be found in Cohen, E. and Gutoff, E. Modern Coating and Drying Technology; VCH Publishers: New York, 1992; p. 122; and in Tricot, Y-M. Surfactants: Static and Dynamic Surface Tension. In Liquid Film Coating; Kistler, S. F. and Schweizer, P. M., Eds.; Chapman & Hall: London, 1997; p. 99.

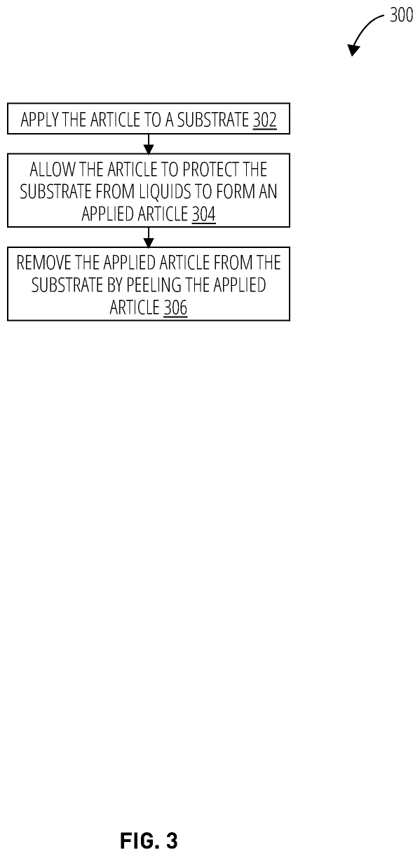

FIG. 3 illustrates a routine 300 for using the article described herein. In block 302, a user can apply the article to a substrate at room temperature. The substrate can be in any orientation as described herein. In at least one embodiment, the substrate is flooring in or adjacent to protected rooms where cleanliness is a factor such as clean rooms, sterile rooms, paint booths, operating rooms, etc.

In block 304, the user can allow the article to protect the substrate from liquids to form a soiled article. For example, the article can absorb/trap any dirt or contaminants (such as liquids) from the foot coverings (e.g., shoes, shoe coverings) of various users before entrance to the protected room. Further, the article can also help to dissipate the static charge as a foot covering contacts the article. If the article is applied to a wall or other non-horizontal surface, then the article can protect the substrate from dust or abrasion from the user to become a soiled article.

In block 306, the user can remove the soiled article from the substrate by peeling the soiled article at room temperature (e.g., without application of heat). The adhesive layer stays attached to the polymer film layer when the soiled article is removed. For example, the adhesive layer can be fully attached to the polymer film layer meaning that no residual adhesive remains on the surface at room temperature. In one embodiment, the adhesive layer can be removed in an intact layer.

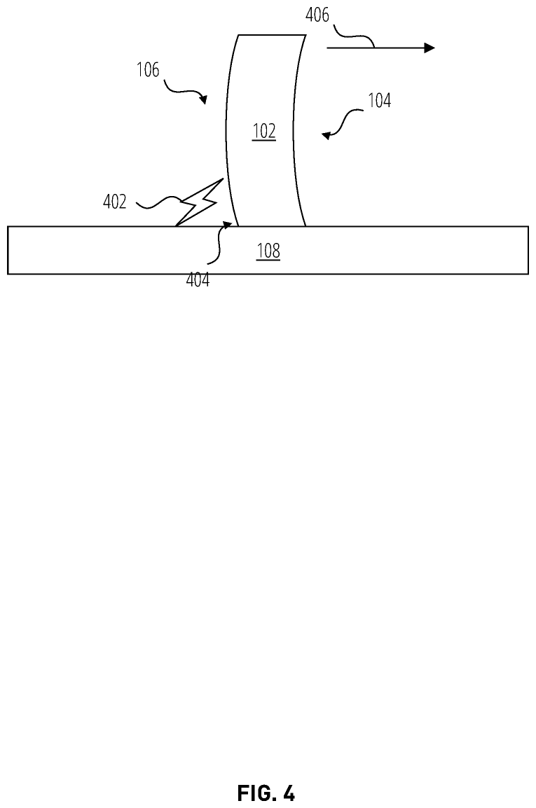

As shown in FIG. 4, the article 102 can be removed from the substrate 108 using a peel force 406 that is between 30 and 180 degrees (inclusive) measured from the substrate 108 (e.g., peel force 406 is depicted at 180 degrees with the product being at 90 degrees). The peel force 406 is sufficient to overcome the peel strength of the adhesive of the article 102. As the article 102 is removed, then a static charge 402 can be produced at the interface 404 where the article 102 contacts the substrate 108. In at least one embodiment, this static charge 402 produced at an interface 404 between the soiled article and the substrate can be dissipated through the polymeric antistatic layer.

In at least one embodiment, the substrate can be a first article surface 104. For example, the article 102 can be stored in a rolled configuration with the adhesive layer from second article surface 106 adhering to the first article surface 104. When in this stored configuration, the first article surface of the article can be separated from a second article surface of the article at an interface. A static charge produced at the interface between the first article surface and the second article surface can be dissipated through the polymeric antistatic layer.

In at least one embodiment, a plurality of articles can be stored as a slab or stack of layers (where a surface of an article has a low-adhesion back size coating). Thus, the static dissipating effect would be produced by the removal of a first article from a second article (e.g., static charge at the interface, dissipated).

“Adhesive” as used herein refers to polymeric compositions useful to adhere together two adherends.

A “conductive polymer” refers to a polymer that is electrically conductive. Some examples of conductive polymers are poly pyrrole, polyaniline, polyacetylene, polythiophene, polyphenylene vinylene, polyphenylene sulfide, poly p-phenylene, polyheterocycle vinylene. The conductive polymers described herein are intrinsically conductive, meaning that they are conductive without the addition of conductive materials such as carbon. PEDOT-PSS is a polymer mixture of two ionomers. One component in this mixture is made up of sodium polystyrene sulfonate which is a sulfonated polystyrene. Part of the sulfonyl groups are deprotonated and carry a negative charge. The other component poly(3,4-ethylenedioxythiophene) or PEDOT is a conjugated polymer and carries positive charges and is based on polythiophene. Together the charged macromolecules form a macromolecular salt. PEDOT-PSS is commercially available as a water dispersion.

“Dissipated” refers to neutralizing a measurable electrostatic voltage. For clarity, it is noted that although the term “conductive” is often used in the industry to refer to “static dissipative”, i.e., antistatic, the terms conductive and antistatic as used herein are not intended to be synonymous. Specifically, a conductive material coating is considered to have a surface resistivity up to 1×10⁵ ohms/sq, whereas an antistatic material coating typically has a surface resistivity between 1×10¹¹ to 6×10¹² ohms/sq (inclusive). These terms are generally used to describe materials having a conductive or antistatic component or agent on an exposed surface of the material. (In comparison, an article can be antistatic by having an antistatic layer “buried” between layers having no antistatic properties, even though the article would exhibit higher levels of surface resistivity.) Furthermore, static decay times can be maintained for the article even with these high surface resistivity values.

“Mil” refers to thousandths of an inch.

A “primer” refers to any component that when used with or coupled to the polymer and/or the substrate or surface, enhances adhesion between a (low surface energy) substrate and an adhesive compared with the substrate and the adhesive without the primer.

As used herein the term “room temperature” or “ambient temperature” are used interchangeably and refer to a temperature of from 20-25° C.

### EXAMPLES

Advantages and embodiments of this invention are further illustrated by the following examples, but the particular materials and amounts thereof recited in these examples, as well as other conditions and details, should not be construed to unduly limit this invention. Foreseeable modifications and alterations of this disclosure will be apparent to those skilled in the art without departing from the scope and spirit of this invention. All parts and percentages are by weight unless otherwise indicated.

The following abbreviations may be used: m=meters; cm=centimeters; mm=millimeters; um=micrometers; ft=feet; in=inch; RPM=revolutions per minute; g=grams; mg=milligrams; kg=kilograms; oz=ounces; lb=pounds; mL=milliliter; L=liter; Pa=Pascals; kPa=kilopascals; see=seconds; min=minutes; hr=hours; psi=pounds per square inch;° C. =degrees Celsius;° F. =degrees Fahrenheit; and phr=parts (by weight) per hundred of resin. The terms “weight %”, “% by weight”, and “wt %” are used interchangeably.

### Materials

TABLE 1
Materials

| Abbreviation | Description/Trade Designation | Supplier |
|---|---|---|
| DMAEA-MCl | N,N-dimethylaminoethyl acrylate | Solenis (Formerly BASF), |
| | methyl chloride quaternary | Wilmington, Delaware |
| IOA | Iso-octyl acrylate | 3M, St. Paul, MN |
| AA | Acrylic acid | Arkema, King of Prussia, |
| | | Pennsylvania |
| MMA | Methyl methacrylate | Mitsubishi Chemical |
| | | Methacrylates, Memphis, |
| | | Tennessee |
| DAAM | Diacetone acrylamide | KH Neochem Americas (Kohjin |
| | | Co), Schaumburg, Illinois |
| DMAEMA | Dimethylaminoethylmethacrylate | Evonik Industries, Parsippany, |
| | | New Jersey |
| VAZO-67 | 2,2′-azo-bis-(2- | Nouryon, Amsterdam, The |
| | methylbutyronitrile) | Netherlands |
| IPA | Isopropyl alcohol | Dow Chemical, Midland, |
| | | Michigan |
| ADH | Adipic acid dihydrazide | KH Neochem Americas (Kohjin |
| | | Co), Schaumburg, Illinois |
| PEDOT-PSS | Clevios P | Heraeus, Leverkusen, Germany |
| DMAE | Amietol 21 | Eastman Chemical Company, |
| | | Kingsport, Tennessee |
| U910 | U 910 Polyurethane Dispersion | Alberdingk-Boley Inc., |
| | | Greensboro NC |
| Dynol607 | Dynol 607 | Evonik Industries AG, Essen |
| | | Germany |

### Test Methods

Static decay: using a Static Decay Analyzer, such as from Electrotech Systems (ETS, Model 4406), a sample of approximately 4 inches (10.16 cm) by 6 inches (15.24 cm) was placed across two electrodes inside a Faraday cage. The sample was held in place by magnets. The sample was charged to a set voltage, such as +5 kV, discharged, and the time for discharge to less than 10% of set voltage was recorded. Samples without an effective static-dissipating construction did not charge to the set voltage in several minutes or discharged slowly, requiring more than one second. Samples with static dissipating components used in sufficient quantity charged quickly to full voltage (less than a few seconds) and discharged in less than 1 second: the most effective samples discharged in less than 0.01 seconds. Both the capacity to charge and to discharge across the two electrodes demonstrates capacity for fast charge movement through the sample span. While higher relative humidity (% RH) may facilitate static decay: the stress test occurred at low humidity (<30% RH).

Adhesion to Stainless Steel (ATSS): one-inch strips of test samples prepared according to the Examples below were cut with a razor hand tool and applied with one pass of a 4.5-pound roller to a clean stainless-steel substrate with platen speed of 90 inches (228.6 cm) per minute using an i-Mass instrument (SP-2000 Model, IMASS, Inc. Accord, MA). To peel, the sample was attached to a baton and the platen moved at 90 inches (228.6 cm) per minute, for a peel front velocity of 45 inches (114.3 cm) per minute. The peel angle was approximately 180 degrees. The average peel force was recorded in oz/in, with a two-second delay and five seconds of averaging. The measurement was collected four times, once for each of four sample segments on stainless steel at 50% relative humidity (RH). Diacetone, ethanol, and heptane were used in the order listed to clean the stainless-steel panel in between testing.

Adhesion to Anodized Aluminum (ATAA): Test samples were prepared as described in the ATSS procedure above. Each sample was adhered to an anodized aluminum surface and peeled to remove at 12 inches (30.5 cm) per minute. With one second delay and five seconds of averaging, the force of sample failure was recorded, and four segments of each sample were tested at 50% RH. For each segment, the average force value (oz/in) was recorded. The anodized aluminum substrates were military type B low voltage sulfuric anodized aluminum coupons and are supplied by Hiawatha Metalcraft (Minneapolis, MN).

### Preparations

The following preparations were used in Examples 1-9 below.

### Synthetic Procedure for the General Solution Polymer

The following procedure was used to synthesize the polymers used in the Examples below. A clean reactor, fitted with a mechanical stirrer, a thermocouple, nitrogen inlet/outlet and a condenser, was charged with the monomers at desired composition (total 100 parts), Vazo-67 (0.5 parts) and IPA (200 parts). The reaction solution was stirred at 150 rpm throughout the preparation. The solution was purged with nitrogen and the reaction run under a slow dynamic purge of nitrogen throughout. The reactor was heated with four IR lamps to 65° C. and kept at 65° C. for 6 hr. Another charge of Vazo-67 (0.3 parts) was added, and the reaction stirred for 12 hours at 65° C. The mixture was cooled to room temperature and the percent solids was measured and revealed >99% completion of the polymerization reaction.

### Preparation of Illustrative and Exemplary Antistatic Polymer Compositions (APCs)

Illustrative and Exemplary Antistatic Polymer Compositions were prepared according to the following procedure, wherein Exemplary APCs denote compositions which additionally comprise ADH. Ingredients for each composition are listed in Table 2, below. Amounts are shown as php (parts per hundred polymer).

For each example below, the above 33% solids polymer solution was placed in a flask, diluted with isopropanol (IPA), and mixed with a mechanical stirrer for 15 minutes. The solution may be diluted to 15% solids or 10% solids, for example. Furthermore, for Exemplary APCs (which include ADH), a 10% water solution of ADH was used to provide APCs having 2 or 4 percent of ADH as calculated on total solids. 3M Primer 94 is commercially available under the trade designation 3M Primer 94 from 3M (Saint Paul, MN).

TABLE 2
Preparation of APCs 1-6

| | DMAEA- | | MMA | AA | DMAEMA | DAAM | ADH |
|---|---|---|---|---|---|---|---|
| APC | MCI (php) | IOA (php) | (php) | (php) | (php) | (php) | (wt %) |
| Illustrative | 30 | 30 | 10 | 5 | 20 | 5 | 0 |
| APC 1 | | | | | | | |
| Illustrative | 30 | 35 | 5 | 5 | 20 | 5 | 0 |
| APC 2 | | | | | | | |
| Exemplary | 30 | 30 | 10 | 5 | 20 | 5 | 2 |
| APC 3 | | | | | | | |
| Exemplary | 30 | 30 | 10 | 5 | 20 | 5 | 4 |
| APC 4 | | | | | | | |
| Exemplary | 30 | 35 | 5 | 5 | 20 | 5 | 2 |
| APC 5 | | | | | | | |
| Exemplary | 30 | 35 | 5 | 5 | 20 | 5 | 4 |
| APC 6 | | | | | | | |
| 3M Primer | Commercially | | | | | | |
| 94 | Available | | | | | | |

### Preparation of Illustrative APC 7

### Illustrative APC 7 was Prepared According to the Following Procedure

Dyno1607 was diluted to 20% Dynol with IPA. DMAE was diluted to 50% with deionized water. 0.04 g of the diluted Dyno1607, 0.02 g of the diluted DMAE, 1.7 g of PEDOT-PSS, 6.8 g of Water, 1.51 g of U910 were placed in a flask, and mixed with a mechanical stirrer for 15 minutes.

### Illustrative and Exemplary Examples 1-4

Articles comprising a fabric layer and a polymeric antistatic layer were prepared according to the following description, wherein the antistatic layers comprised the antistatic polymer compositions (APC 1-4) prepared as described above.

A nonwoven and low-density polyethylene film laminate was provided. APCs 1-6 were coated onto the film side of the laminate using a #6 Mayer rod at a coating weight of about 9 g/m². The articles were dried at 66° C. for about 10 minutes, forming a fabric article comprising an antistatic primer layer. The resulting film had a thickness of about 10 microns. Adhesive was applied through lamination with an adhesive transfer tape and hot-press at ˜300° F. for 4-5 seconds. The adhesive used was a hot melt acrylate adhesive. Illustrative and Exemplary APCs 1-4 were used in the construction of, respectively, Illustrative and Exemplary Examples 1-4.

Examples 1-4 were tested following the procedures described above. Results are reported in Table 3.

TABLE 3
Examples and measurements

| | | ATAA | Static Decay Test | |
|---|---|---|---|---|
| Examples | Formula | (oz/in) | Voltage (kV) | Decay (s) |
| Illustrative Example 1 | APC 1 | 20.9 | 4.92 | 0.002 |
| Exemplary Example 2 | APC 2 | 24.4 | 4.42 | 0.002 |
| Exemplary Example 3 | APC 3 | 29.7 | 5.13 | 0.002 |
| Exemplary Example 4 | APC 4 | 28.1 | 4.57 | 0.002 |

In Table 3, all samples coated with polymeric antistatic layer demonstrate fast static decay. The addition of ADH in examples 3 and 4 demonstrates increased ATAA (oz/in) values.

### Comparative and Exemplary Examples 5-8

Articles comprising a fabric layer and polymeric antistatic layer were prepared similarly to the Illustrative and Exemplary Examples 1-4 except that the polymeric antistatic layer was coated using a gravure roll (a 5 BCM roll for Comparative Example, or Example 5-8 used a 10 BCM roll) and dried with an in-line oven. An acrylic hot-melt adhesive commercially available from the 3M Self-Stick Liquid Protection Fabric was coated onto the antistatic primer layers by extrusion using a rotary rod die to form Examples.

Examples 5-8 and the Comparative Example were tested following the procedures described above. Results are reported in Table 4, below, wherein N/M stands for “not measured”.

TABLE 4

| | | | | Static Decay Test | | |
|---|---|---|---|---|---|---|
| | | ATSS | ATAA | | Voltage | Decay |
| Examples | Formula | (oz/in) | (oz/in) | % RH | (kV) | (s) |
| Comparative | 3M ™ | 17.8 | 44.8 | 15 | No | N/M |
| Example | Primer 94 | | | | charge | |
| Exemplary | APC 3 | 17.3 | 38.1 | 16 | 4.9 | 0.008 |
| Example 5 | | | | | | |
| Exemplary | APC 4 | 18.2 | 37.2 | 16 | 5.3 | 0.009 |
| Example 6 | | | | | | |
| Exemplary | APC 5 | 18.4 | 39.1 | 16 | 5.2 | 0.014 |
| Example 7 | | | | | | |
| Exemplary | APC 6 | 18.9 | 42.7 | 16 | 5.2 | 0.013 |
| Example 8 | | | | | | |

The decay of the Comparative Example was not measured because the tester was unable to charge to the set voltage of 5 kV, therefore the decay was not possible to measure.

### Illustrative Example 9

The nonwoven and low-density polyethylene film laminate was provided. APC 7 was coated onto the film side of the laminate using a #3 Mayer rod. The resulting film had a wet thickness of 6.9 micrometers. The article was dried at 66° C. for about 4 minutes, forming a fabric article comprising an antistatic primer layer. After drying, 3M Primer 94 was applied over the dried APC 7 using the #3 Mayer rod at 6.9 micrometer wet thickness. The article was dried at 66° C. for about 4 minutes, forming a fabric article comprising an antistatic primer layer and the 3M Primer 94. Adhesive was applied through lamination with an adhesive transfer tape and hot-press at ˜300° F. for 4-5 seconds. The adhesive used was a hot melt acrylate adhesive. The following data in Table 5 was gathered at 73° F./50% relative humidity.

TABLE 5

| | | | 1% Cut-off Charge Decay | |
|---|---|---|---|---|
| | | ATAA, | | Decay |
| Example | Formula | oz/in | Voltage, kV | Time, s |
| Illustrative | APC 7 and 3M | 49.1 | 5 | 0.01 |
| Example 9 | Primer 94 | | | |

In some embodiments, it is desired that the adhesion to anodized aluminum (ATAA) is greater than adhesion to stainless steel (ATSS). The example constructed with 3M Primer 94 has a favorable ATAA value but did not charge and discharge static. Examples constructed with the polymeric antistatic layer have favorable ATAA values and fast static dissipation.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

1. An article comprising:
a fabric layer having a first fabric side and a second fabric side; and
a polymeric antistatic layer disposed in a direction towards the second fabric side, wherein the polymeric antistatic layer comprises an antistatic polymer.

2. The article of claim 1, wherein the fabric layer comprises a nonwoven fabric, woven fabric, knitted fabric, or combinations thereof.

3. The article of claim 1, wherein the antistatic polymer is a primer for an adhesive layer.

4. The article of claim 1, further comprising:
a polymer film layer having a first film side and a second film side;
wherein the polymer film layer is sandwiched between the fabric layer and the polymeric antistatic layer.

5. The article of claim 4, wherein the first film side is disposed on the second fabric side, and the polymeric antistatic layer is disposed on the second film side.

6. The article of claim 5, wherein the polymeric antistatic layer has a first antistatic side and a second antistatic side, wherein the first antistatic side contacts the second film side.

7. The article of claim 1, further comprising an adhesive layer having a first adhesive side and a second adhesive side, wherein the first adhesive side is disposed on the polymeric antistatic layer.

8. The article of claim 7, wherein the first adhesive side is disposed on the second antistatic side.

9. The article of claim 8, wherein a charge decay of the article is less than 0.02 seconds between 16% and 30% (inclusive) relative humidity.

10. The article of claim 1, wherein the polymeric antistatic layer comprises an acrylate copolymer, comprising a crosslinking agent in an amount of at least 2 weight percent of the total weight of the polymeric antistatic layer.

11. The article of claim 10, wherein the crosslinking agent comprises diacetone acrylamide.

12. The article of claim 10, wherein the crosslinking agent is a difunctional crosslinking agent, the difunctional crosslinking agent is adipic dihydrazide or adipic acid dihydrazide.

13. The article of claim 1, wherein the article does not include metal or metal salts thereof or non-polymeric quaternary ammonium salts such as ammonium chloride.

14. The article of claim 1, wherein only the polymeric antistatic layer has antistatic properties.

15. The article of claim 14, wherein the fabric layer or adhesive layer is not treated with antistatic materials.

16. The article of claim 1, wherein the polymeric antistatic layer comprises a primer layer and a conductive polymer layer.

17. The article of claim 16, wherein the conductive polymer layer comprises PEDOT-PSS.

18.-19. (canceled)

20. A method comprising:
applying the article of claim 1 to a substrate at room temperature;
allowing the article to protect the substrate from liquids to form a soiled article;
removing the soiled article from the substrate by peeling the soiled article at room temperature.

21. The method of claim 20, wherein a static charge produced at an interface between the soiled article and the substrate is dissipated through the polymeric antistatic layer.

22. The method of claim 21, wherein the adhesive layer stays attached to a polymer film layer when the soiled article is removed.

23. (canceled)
